(19) United States
(12) Patent Application Publication
(10) Pub. No.: US 2024/0122261 A1
(43) Pub. Date: Apr. 18, 2024

(54) SYSTEM AND METHOD OF AEROSOL DELIVERY

(71) Applicant: Nicoventures Trading Limited, London (GB)

(72) Inventor: Patrick MOLONEY, London (GB)

(21) Appl. No.: 17/754,899

(22) PCT Filed: Sep. 17, 2020
(86) PCT No.: PCT/GB2020/052247

§ 371 Date: Apr. 15, 2022

(30) Foreign Application Priority Data
Oct. 16, 2019 (GB) 1914948.3

(51) Int. Cl. A24F 40/53; A24F 40/65

(52) U.S. Cl. CPC A24F 40/53; A24F 40/65

(57) ABSTRACT

A computing device for use with an aerosol provision system, configured to generate aerosol from an aerosol generating material for user inhalation, is configured to obtain a first data set, the first data set including data relating to usage of the aerosol provision system, obtain a further data set, the further data set including data associated with the user of the aerosol provision system and not relating to usage of the aerosol provision system, identify a correspondence between usage in the first data set and one or more respective characteristic features of the further data set, and in response to a circumstance having a feature similar to a respective characteristic feature in the further data set, adjust one or more operational parameters of the aerosol provision system responsive to the corresponding usage of the aerosol provision system indicated in the first data set.

### PRIORITY claim

The present application is a National Phase entry of PCT Application No. PCT/GB2020/052247, filed Sep. 17, 2020, which claims priority from Great Britain Application No. 1914948.3, filed Oct. 16, 2019, each of which is hereby fully incorporated herein by reference.

### TECHNICAL FIELD

The present disclosure relates to a system and method of aerosol delivery.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Electronic aerosol provision systems such as electronic cigarettes (e-cigarettes) generally contain a reservoir of a source liquid containing a formulation, typically including nicotine, from which an aerosol is generated, e.g. through heat vaporization. An aerosol source for an aerosol provision system may thus comprise a heater having a heating element arranged to receive source liquid from the reservoir, for example through wicking/capillary action. Other source materials may be similarly heated to create an aerosol, such as botanical matter, or a gel comprising an active ingredient and/or flavoring. Hence more generally, the e-cigarette may be thought of as comprising or receiving a payload for heat vaporization.

While a user inhales on the device, electrical power is supplied to the heating element to vaporize the aerosol source (a portion of the payload) in the vicinity of the heating element, to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Usually an electric current is supplied to the heater when a user is drawing/puffing on the device. Typically, the electric current is supplied to the heater, e.g. resistance heating element, in response to either the activation of an airflow sensor along the flow path as the user inhales/draw/puffs or in response to the activation of a button by the user. The heat generated by the heating element is used to vaporize a formulation. The released vapor mixes with air drawn through the device by the puffing consumer and forms an aerosol. Alternatively or in addition, the heating element is used to heat but typically not burn a botanical such as tobacco, to release active ingredients thereof as a vapor/aerosol.

The amount of vaporized/aerosolized payload inhaled by the user will depend at least in part on how long and how deeply the user inhales and, over a period of time, how frequently the user inhales as well. In turn, these user behaviors may be influenced by their mood.

Embodiments of the present disclosure aim to improve the delivery of the payload to a user whose consumption may be influenced by their mood.

### SUMMARY

In one aspect of the present disclosure a computing device for use with an aerosol provision system configured to generate aerosol from an aerosol generating material for user inhalation is configured to obtain a first data set, the first data set including data relating to usage of the aerosol provision system. The device can be configured to obtain a further data set, or a plurality of further data sets, each further data set including data associated with the user of the aerosol provision system and not relating to usage of the aerosol provision system. The device can be configured to identify a correspondence between usage in the first data set and one or more respective characteristic features of at least one of the one or more further data sets. In response to a circumstance having a feature similar to a respective characteristic feature in the at least one further data set, the device can adjust one or more operational parameters of the aerosol provision system responsive to the corresponding usage of the aerosol provision system indicated in the first data set.

In embodiments, the computing device can be further configured to identify a correspondence between usage in the first data set and one or more respective types of feature of each further data set, and in response to a circumstance having a feature of the respective type identified in at least one further data set, adjust the operational parameters of the aerosol provision system responsive to the corresponding type of event in the first data set.

In embodiments, at least one further data set of the one or more further data sets relates to ones of an environmental condition or a user interaction with a website. In embodiments the further data sets do not relate to a physiological aspect of the user. The first data set can further relate to an inhalation profile of the user or an amount of inhaled aerosol.

In embodiments, the identified correspondence between usage in the first data set and one or more respective characteristic features of at least one of the one or more further data sets can be a correspondence in time.

In embodiments, operational parameters are adjusted in anticipation of the corresponding usage. The operational parameters can be operational parameters are adjusted at a predetermined variance to the corresponding usage.

In embodiments, the functions of the computing device can be provided by one or more of:
i. a mobile phone operable to communicate with an electronic vapor provision system;
ii. an electronic vapor provision system; and/or
iii. a server operable to communicate with one or more of an electronic vapor provision system and a mobile phone itself operable to communicate with an electronic vapor provision system.

In one aspect of the present disclosure, an aerosol delivery method for use with an aerosol provision system configured to generate aerosol from an aerosol generating material for user inhalation includes: obtaining a first data set, the first data set including data relating to usage of the aerosol provision system, obtaining one or more further data sets, each further data set including data associated with the user of the aerosol provision system and not relating to usage of the aerosol provision system, identifying a correspondence between usage in the first data set and one or more respective characteristic features of at least one of the one or more the further data set and in response to a circumstance having a feature similar to a respective characteristic feature in the at least one further data set, adjusting one or more operational parameters of the aerosol provision system responsive to the corresponding usage of the aerosol provision system indicated in the first data set.

In one aspect of the present disclosure, a non-transitory computer-readable medium storing instructions that, when executed by computer system, cause the computer system to perform on or more of the methods disclosed herein.

It is to be understood that both the foregoing general summary of the disclosure and the following detailed description are provided for the purposes of example, and are not intended to be restrictive of the disclosure. Further aspects are provided in accordance with the claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings.

FIG. 1 is a schematic diagram depicting an electronic aerosol/vapor provision system (EVPS), according to an embodiment.

FIG. 2 is a schematic diagram depicting further details of the EVPS of FIG. 1.

FIG. 3 is a schematic diagram depicting further details of the EVPS of FIG. 1.

FIG. 4 is a schematic diagram depicting further details of the EVPS of FIG. 1.

FIG. 5 is a schematic diagram depicting a system comprising the EVPS of FIG. 1 and a remote device, according to an embodiment.

FIG. 6 is a flowchart depicting an aerosol provision method, according to an embodiment.

### DETAILED DESCRIPTION

An electronic aerosol provision system and method are disclosed. In the following description, a number of specific details are presented in order to provide a thorough understanding of the embodiments of the present disclosure. It will be apparent, however, to a person of ordinary skill in the art that these specific details need not be employed to practice embodiments of the present disclosure. Conversely, specific details known to the person skilled in the art are omitted for the purposes of clarity where appropriate.

As described above, the present disclosure relates to an aerosol provision system (e.g. a non-combustible aerosol provision system) or electronic vapor provision system (EVPS), such as an e-cigarette. Throughout the following description the term “e-cigarette” is sometimes used but this term may be used interchangeably with (electronic) aerosol/vapor provision system. Similarly the terms ‘vapor’ and ‘aerosol’ are referred to equivalently herein.

Generally, the electronic vapor/aerosol provision system may be an electronic cigarette, also known as a vaping device or electronic nicotine delivery system (END), although it is noted that the presence of nicotine in the aerosolizable material is not a requirement. In some embodiments, a non-combustible aerosol provision system is a tobacco heating system, also known as a heat-not-burn system. In some embodiments, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In some embodiments, the hybrid system comprises a liquid or gel aerosolizable material and a solid aerosolizable material. The solid aerosolizable material may comprise, for example, tobacco or a non-tobacco product. Meanwhile in some embodiments, the non-combustible aerosol provision system generates a vapor/aerosol from one or more such aerosolizable materials.

Typically, the non-combustible aerosol provision system may comprise a non-combustible aerosol provision device and an article for use with the non-combustible aerosol provision system. However, it is envisaged that articles which themselves comprise a means for powering an aerosol generating component may themselves form the non-combustible aerosol provision system. In one embodiment, the non-combustible aerosol provision device may comprise a power source and a controller. The power source may be an electric power source or an exothermic power source. In one embodiment, the exothermic power source comprises a carbon substrate which may be energized so as to distribute power in the form of heat to an aerosolizable material or heat transfer material in proximity to the exothermic power source. In one embodiment, the power source, such as an exothermic power source, is provided in the article so as to form the non-combustible aerosol provision. In one embodiment, the article for use with the non-combustible aerosol provision device may comprise an aerosolizable material.

In some embodiments, the aerosol generating component is a heater capable of interacting with the aerosolizable material so as to release one or more volatiles from the aerosolizable material to form an aerosol. In one embodiment, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

In some embodiments, the aerosolizable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolizable material in order to achieve a physiological response other than olfactory perception. The aerosol forming material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. The one or more functional materials may comprise one or more of flavors, carriers, pH regulators, stabilizers, and/or antioxidants.

In some embodiments, the article for use with the non-combustible aerosol provision device may comprise aerosolizable material or an area for receiving aerosolizable material. In one embodiment, the article for use with the non-combustible aerosol provision device may comprise a mouthpiece. The area for receiving aerosolizable material may be a storage area for storing aerosolizable material. For example, the storage area may be a reservoir. In one embodiment, the area for receiving aerosolizable material may be separate from, or combined with, an aerosol generating area.

Referring now to the drawings, wherein like reference numerals designate identical or corresponding parts throughout the several views,

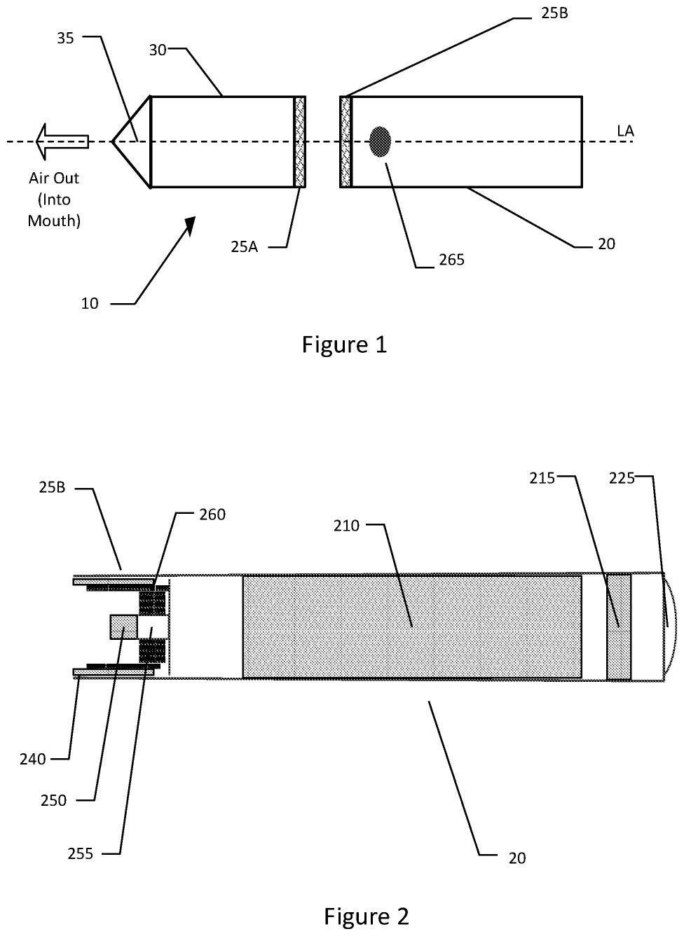

FIG. 1 is a schematic diagram of an electronic vapor/aerosol provision system such as an e-cigarette 10 in accordance with some embodiments of the disclosure (not to scale). The e-cigarette has a generally cylindrical shape, extending along a longitudinal axis indicated by dashed line LA, and comprises two main components, namely a body 20 and a cartomizer 30. The cartomizer includes an internal chamber containing a reservoir of a payload such as for example a liquid comprising nicotine, a vaporizer (such as a heater), and a mouthpiece 35. References to ‘nicotine’ hereafter will be understood to be merely for the purposes of example and can be substituted with any suitable active ingredient. References to ‘liquid’ as a payload hereafter will be understood to be merely exemplary and can be substituted with any suitable payload such as botanical matter (for example tobacco that is to be heated rather than burned), or a gel comprising an active ingredient and/or flavoring. The reservoir may be a foam matrix or any other structure for retaining the liquid until such time that it is required to be delivered to the vaporizer. In the case of a liquid/flowing payload, the vaporizer is for vaporizing the liquid, and the cartomizer 30 may further include a wick or similar facility to transport a small amount of liquid from the reservoir to a vaporizing location on or adjacent the vaporizer. In the following, a heater is used as a specific example of a vaporizer. However, it will be appreciated that other forms of vaporizer (for example, those which utilize ultrasonic waves) could also be used and it will also be appreciated that the type of vaporizer used may also depend on the type of payload to be vaporized.

The body 20 includes a re-chargeable cell or battery to provide power to the e-cigarette 10 and a circuit board for generally controlling the e-cigarette. When the heater receives power from the battery, as controlled by the circuit board, the heater vaporizes the liquid and this vapor is then inhaled by a user through the mouthpiece 35. In some specific embodiments the body is further provided with a manual activation device 265, e.g. a button, switch, or touch sensor located on the outside of the body.

The body 20 and cartomizer 30 may be detachable from one another by separating in a direction parallel to the longitudinal axis LA, as shown in FIG. 1, but are joined together when the device 10 is in use by a connection, indicated schematically in FIG. 1 as 25A and 25B, to provide mechanical and electrical connectivity between the body 20 and the cartomizer 30. The electrical connector 25B on the body 20 that is used to connect to the cartomizer 30 also serves as a socket for connecting a charging device (not shown) when the body 20 is detached from the cartomizer 30. The other end of the charging device may be plugged into a USB socket to re-charge the cell in the body 20 of the e-cigarette 10. In other implementations, a cable may be provided for direct connection between the electrical connector 25B on the body 20 and a USB socket.

The e-cigarette 10 is provided with one or more holes (not shown in FIG. 1) for air inlets. These holes connect to an air passage through the e-cigarette 10 to the mouthpiece 35. When a user inhales through the mouthpiece 35, air is drawn into this air passage through the one or more air inlet holes, which are suitably located on the outside of the e-cigarette. When the heater is activated to vaporize the nicotine from the cartridge, the airflow passes through, and combines with, the generated vapor, and this combination of airflow and generated vapor then passes out of the mouthpiece 35 to be inhaled by a user. Except in single-use devices, the cartomizer 30 may be detached from the body 20 and disposed of when the supply of liquid is exhausted (and replaced with another cartomizer if so desired).

It will be appreciated that the e-cigarette 10 shown in FIG. 1 is presented by way of example, and various other implementations can be adopted. For example, in some embodiments, the cartomizer 30 is provided as two separable components, namely a cartridge comprising the liquid reservoir and mouthpiece (which can be replaced when the liquid from the reservoir is exhausted), and a vaporizer comprising a heater (which is generally retained). As another example, the charging facility may connect to an additional or alternative power source, such as a car cigarette lighter.

FIG. 2 is a schematic (simplified) diagram of the body 20 of the e-cigarette 10 of FIG. 1 in accordance with some embodiments of the disclosure. FIG. 2 can generally be regarded as a cross-section in a plane through the longitudinal axis LA of the e-cigarette 10. Note that various components and details of the body, e.g. such as wiring and more complex shaping, have been omitted from FIG. 2 for reasons of clarity.

The body 20 includes a battery or cell 210 for powering the e-cigarette 10 in response to a user activation of the device. Additionally, the body 20 includes a control unit (not shown in FIG. 2), for example a chip such as an application specific integrated circuit (ASIC) or microcontroller, for controlling the e-cigarette 10. The microcontroller or ASIC includes a CPU or micro-processor. The operations of the CPU and other electronic components are generally controlled at least in part by software programs running on the CPU (or other component). Such software programs may be stored in non-volatile memory, such as ROM, which can be integrated into the microcontroller itself, or provided as a separate component. The CPU may access the ROM to load and execute individual software programs as and when required. The microcontroller also contains appropriate communications interfaces (and control software) for communicating as appropriate with other devices in the body 10.

The body 20 further includes a cap 225 to seal and protect the far (distal) end of the e-cigarette 10. Typically there is an air inlet hole provided in or adjacent to the cap 225 to allow air to enter the body 20 when a user inhales on the mouthpiece 35. The control unit or ASIC may be positioned alongside or at one end of the battery 210. In some embodiments, the ASIC is attached to a sensor unit 215 to detect an inhalation on mouthpiece 35 (or alternatively the sensor unit 215 may be provided on the ASIC itself). An air path is provided from the air inlet through the e-cigarette, past the airflow sensor 215 and the heater (in the vaporizer or cartomizer 30), to the mouthpiece 35. Thus when a user inhales on the mouthpiece of the e-cigarette, the CPU detects such inhalation based on information from the airflow sensor 215.

At the opposite end of the body 20 from the cap 225 is the connector 25B for joining the body 20 to the cartomizer 30. The connector 25B provides mechanical and electrical connectivity between the body 20 and the cartomizer 30. The connector 25B includes a body connector 240, which is metallic (silver-plated in some embodiments) to serve as one terminal for electrical connection (positive or negative) to the cartomizer 30. The connector 25B further includes an electrical contact 250 to provide a second terminal for electrical connection to the cartomizer 30 of opposite polarity to the first terminal, namely body connector 240. The electrical contact 250 is mounted on a coil spring 255. When the body 20 is attached to the cartomizer 30, the connector 25A on the cartomizer 30 pushes against the electrical contact 250 in such a manner as to compress the coil spring in an axial direction, i.e. in a direction parallel to (co-aligned with) the longitudinal axis LA. In view of the resilient nature of the spring 255, this compression biases the spring 255 to expand, which has the effect of pushing the electrical contact 250 firmly against connector 25A of the cartomizer 30, thereby helping to ensure good electrical connectivity between the body 20 and the cartomizer 30. The body connector 240 and the electrical contact 250 are separated by a trestle 260, which is made of a non-conductor (such as plastic) to provide good insulation between the two electrical terminals. The trestle 260 is shaped to assist with the mutual mechanical engagement of connectors 25A and 25B.

As mentioned above, a button 265, which represents a form of manual activation device 265, may be located on the outer housing of the body 20. The button 265 may be implemented using any appropriate mechanism which is operable to be manually activated by the user—for example, as a mechanical button or switch, a capacitive or resistive touch sensor, and so on. It will also be appreciated that the manual activation device 265 may be located on the outer housing of the cartomizer 30, rather than the outer housing of the body 20, in which case, the manual activation device 265 may be attached to the ASIC via the connections 25A, 25B. The button 265 might also be located at the end of the body 20, in place of (or in addition to) cap 225.

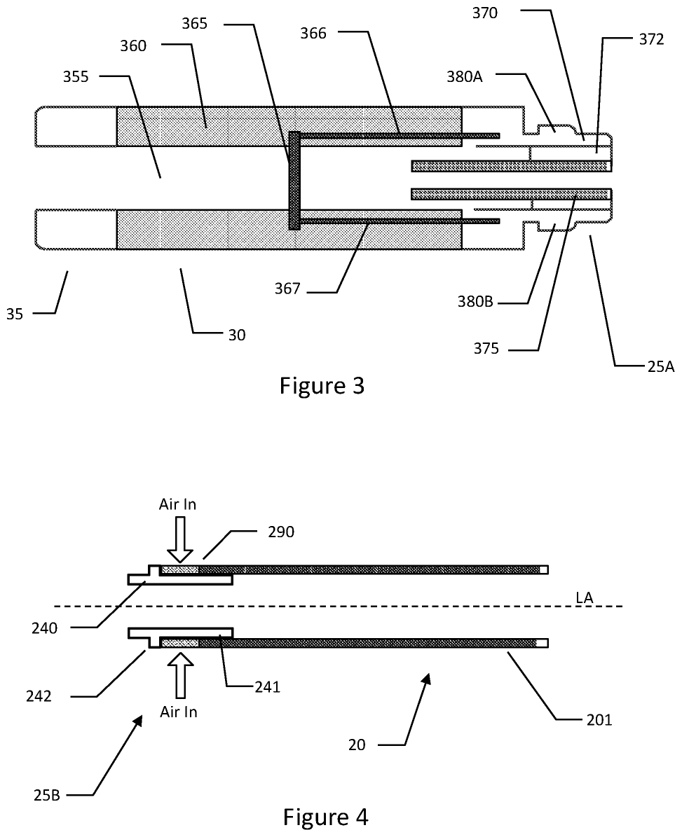

FIG. 3 is a schematic diagram of the cartomizer 30 of the e-cigarette 10 of FIG. 1 in accordance with some embodiments of the disclosure. FIG. 3 can generally be regarded as a cross-section in a plane through the longitudinal axis LA of the e-cigarette 10. Note that various components and details of the cartomizer 30, such as wiring and more complex shaping, have been omitted from FIG. 3 for reasons of clarity.

The cartomizer 30 includes an air passage 355 extending along the central (longitudinal) axis of the cartomizer 30 from the mouthpiece 35 to the connector 25A for joining the cartomizer to the body 20. A reservoir of liquid 360 is provided around the air passage 335. This reservoir 360 may be implemented, for example, by providing cotton or foam soaked in liquid. The cartomizer 30 also includes a heater 365 for heating liquid from reservoir 360 to generate vapor to flow through air passage 355 and out through mouthpiece 35 in response to a user inhaling on the e-cigarette 10. The heater 365 is powered through lines 366 and 367, which are in turn connected to opposing polarities (positive and negative, or vice versa) of the battery 210 of the main body 20 via connector 25A (the details of the wiring between the power lines 366 and 367 and connector 25A are omitted from FIG. 3).

The connector 25A includes an inner electrode 375, which may be silver-plated or made of some other suitable metal or conducting material. When the cartomizer 30 is connected to the body 20, the inner electrode 375 contacts the electrical contact 250 of the body 20 to provide a first electrical path between the cartomizer 30 and the body 20. In particular, as the connectors 25A and 25B are engaged, the inner electrode 375 pushes against the electrical contact 250 so as to compress the coil spring 255, thereby helping to ensure good electrical contact between the inner electrode 375 and the electrical contact 250.

The inner electrode 375 is surrounded by an insulating ring 372, which may be made of plastic, rubber, silicone, or any other suitable material. The insulating ring is surrounded by the cartomizer connector 370, which may be silver-plated or made of some other suitable metal or conducting material. When the cartomizer 30 is connected to the body 20, the cartomizer connector 370 contacts the body connector 240 of the body 20 to provide a second electrical path between the cartomizer 30 and the body 20. In other words, the inner electrode 375 and the cartomizer connector 370 serve as positive and negative terminals (or vice versa) for supplying power from the battery 210 in the body 20 to the heater 365 in the cartomizer 30 via supply lines 366 and 367 as appropriate.

The cartomizer connector 370 is provided with two lugs or tabs 380A, 380B, which extend in opposite directions away from the longitudinal axis of the e-cigarette 10. These tabs are used to provide a bayonet fitting in conjunction with the body connector 240 for connecting the cartomizer 30 to the body 20. This bayonet fitting provides a secure and robust connection between the cartomizer 30 and the body 20, so that the cartomizer and body are held in a fixed position relative to one another, with minimal wobble or flexing, and the likelihood of any accidental disconnection is very small. At the same time, the bayonet fitting provides simple and rapid connection and disconnection by an insertion followed by a rotation for connection, and a rotation (in the reverse direction) followed by withdrawal for disconnection. It will be appreciated that other embodiments may use a different form of connection between the body 20 and the cartomizer 30, such as a snap fit or a screw connection.

FIG. 4 is a schematic diagram of certain details of the connector 25B at the end of the body 20 in accordance with some embodiments of the disclosure (but omitting for clarity most of the internal structure of the connector as shown in FIG. 2, such as trestle 260). In particular, FIG. 4 shows the external housing 201 of the body 20, which generally has the form of a cylindrical tube. This external housing 201 may comprise, for example, an inner tube of metal with an outer covering of paper or similar. The external housing 201 may also comprise the manual activation device 265 (not shown in FIG. 4) so that the manual activation device 265 is easily accessible to the user.

The body connector 240 extends from this external housing 201 of the body 20. The body connector 240 as shown in FIG. 4 comprises two main portions, a shaft portion 241 in the shape of a hollow cylindrical tube, which is sized to fit just inside the external housing 201 of the body 20, and a lip portion 242 which is directed in a radially outward direction, away from the main longitudinal axis (LA) of the e-cigarette. Surrounding the shaft portion 241 of the body connector 240, where the shaft portion does not overlap with the external housing 201, is a collar or sleeve 290, which is again in a shape of a cylindrical tube. The collar 290 is retained between the lip portion 242 of the body connector 240 and the external housing 201 of the body, which together prevent movement of the collar 290 in an axial direction (i.e. parallel to axis LA). However, collar 290 is free to rotate around the shaft portion 241 (and hence also axis LA).

As mentioned above, the cap 225 is provided with an air inlet hole to allow air to flow when a user inhales on the mouthpiece 35. However, in some embodiments the majority of air that enters the device when a user inhales flows through collar 290 and body connector 240 as indicated by the two arrows in FIG. 4.

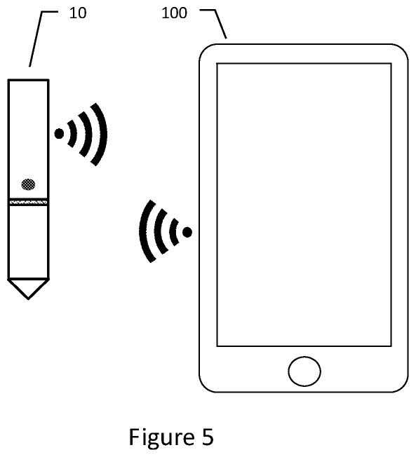

Referring now to FIG. 5, in an embodiment of the present disclosure a system to provide a more responsive electronic vapor provision system (EVPS) may comprise two components, such as an EVPS/e-cigarette 10 and a mobile phone or similar device (such as a tablet) 100 operable to communicate with the e-cigarette (for example to at least receive data from the e-cigarette), for example via Bluetooth®. In this case, the phone provides wider data gathering and processing capability to generate the responsiveness as described later herein.

However it will be appreciated that whilst the use of two such components is likely, it is also envisaged that an EVPS/e-cigarette with suitable communication and/or user interface capabilities may implement such a system by itself.

In any event, a computing device is provided for use with an aerosol provision system configured to generate aerosol from an aerosol generating material for user inhalation (e.g. by means of a remote device such a mobile phone or a server, or by means of suitable components within the EVPS itself).

The computing device is configured to obtain a first data set, the first data set including data relating to usage of the aerosol provision system. Typically for a separate device such a mobile phone this data is obtained from the EVPS for example via a Bluetooth® or another wireless connection. Meanwhile optionally some data may be obtained locally by the computing device, for example when the mobile phone acts as a user interface for the EVPS for certain functions, or derives additional data from the first data set.

This first data set may comprise a variety of descriptors of usage of the EVPS by the user. In some cases, the data set may already be generated for the purposes, or alternatively some or all of the data set may be generated specifically for use by the present techniques. Optionally, only a subset of a generated data set may be used by the present techniques if not all of the descriptors of usage within the data set are considered relevant.

In a first example, the first data set may comprise data relating to inhalation profiles of the user. An inhalation profile may be taken as indicative of how the user inhales on the EVPS, in terms of one or more of overall duration, peak airflow rate, average airflow rate, overall volume of air inhaled, initial rate of inhalation, and/or an airflow rate envelope. It will be appreciated that the data may in fact use any suitable proxy for airflow, such as a change in pressure from a pressure sensor of the EVPS. Optionally the computing device may generate descriptors for the first data set from other data in the first data set; for example given the airflow rate and overall duration of inhalation, and overall volume of air/vapor inhaled during an inhalation may be calculated.

In this example typically the first data set will provide this information as a function of time, associating inhalations with timestamps.

Optionally, the inhalation profiles in the first data set may be provided according to a classification such as short vs. long, deep vs. shallow, rather than providing the specific values underlying such classification. Alternatively or in addition, the computing device may make such classifications based upon the first dataset.

Optionally, in this example the first data set may not include data for individual inhalations, but provide average values for time periods throughout the day, for example at one hour, half-hour, quarter hour, 10 minute or five minute intervals.

The inhalation profile data of the first dataset can also be extended to characterize the patterns of multiple inhalations over time. In particular, the frequency of inhalations may be characterize over time. Again optionally this may be provided for time periods throughout the day, for example at one hour, half-hour, quarter hour, 10 minute or five minute intervals.

Similarly, the regularity of inhalations can be characterize, for example based on a standard deviation from the average inhalation frequency at any given time, again optionally sampled within time periods of a given interval.

In a second example, alternatively or in addition the first data set may comprise data relating to an amount of inhaled aerosol. Optionally this can relate to the effective strength of the active ingredient within the EVPS, which may be standardized at manufacture, or may vary if refills are user serviceable. In this case, the composition of the refill may be detected automatically by the EVPS based on any suitable identification technique, or maybe acquired for example by the mobile phone scanning a QR code on packaging of the refill to obtain the relevant information.

This information can be used to estimate active ingredient consumption per inhalation or over a suitable timeframe (such as any of the periods described above), for example in conjunction with individual average inhalation profiles indicating the amount of air/vapor inhaled, in conjunction with the effective strength of the active ingredient.

Optionally the data can also relate to physiological properties of the user, such as body weight and/or apparent maximum inhalation capacity.

This information can be used to estimate the levels of active ingredient within the user's body over a suitable timeframe (such as any of the periods described above).

More generally, the first data set may comprise any usage of the EVPS relating to the delivery of vapor to the user, and by extension the delivery of the vapor's active ingredient to the user. Hence for example dialing a temperature setting on the EVPS up or down may be considered a usage, as might making adjustments to an air intake or mouthpiece that alters effective airflow or vapor density. Similarly swapping out payloads to change the effective strength of the active ingredient could also be considered a usage. Again such activities could be associated with a timestamp or time period such as one of those described above.

Meanwhile, simply fiddling or toying with the EVPS, or holding it in their hand rather than in a bag, do not relate to the delivery of vapor to the user but rather are indicative of habits or behaviors of the user. Therefore these do not relate to usage of the aerosol provision system in the sense of using it to deliver a vapor to the user.

However, it will be understood that there may nevertheless be clear correlations between taking the EVPS out of a bag, or starting to toy with it rather than simply holding it, and a subsequent usage of the EVPS in terms of inhalation. For example, if the EVPS has been in a bag this may be indicative that it has not been used for a while, and so taking it out of the bag may indicate a desire to use it comparatively more frequently than normal in the short term. Meanwhile toying with the EVPS rather than merely holding it may indicate agitation, and correlate with a higher than average rate or depth of inhalation. Any actual correlations will vary from user to user, and potentially from time period to time period.

Consequently data relating to motion detection and/or touch detection of the EVPS is an example of all or part of a further data set including data associated with the user of the aerosol provision system, but not relating to actual usage of the aerosol provision system (in the sense of using it to generate aerosol).

Hence in an embodiment of the present disclosure, the computing device is configured to obtain at least one such further data set, the further data set including data associated with the user of the aerosol provision system and not relating to usage of the aerosol provision system.

As will be explained below, such further datasets may be diverse in nature and so may be obtained in a variety of ways. Some may come from the EVPS, such as the motion and/or touch detection described above, whilst others may come from other devices of the user, or from the computing device itself (e.g. a phone), or from external sources, for example via the Internet.

Such further datasets may comprise data from one or more of at least three broad categories, provided as non-limiting examples:
i. data relating to the current physical state of the user;
ii. data relating to user originating circumstances; and
iii. data relating to external circumstances.

Whilst the first category may comprise data relating to a physiological aspect of the user, the second and third categories may not. Typically the use of such data sets will require or benefit from the user's informed consent, in part because if the user knows that a certain circumstance/event may contribute towards an improved experience with their EVPS, they are likely to be more willing to provide information about such circumstances back to the computing device.

i. Data Relating to the Current Physical State of the User:

Examples of this data include behavioral data, such as the toying example given above, and potentially also other factors such as the user's facial expression, tone of voice or vocabulary (for example as captured by a mobile phone or digital assistant, potentially during other uses, such as during a phone call). Similarly other interactions indicative of mood with other devices including the computing device itself or other devices potentially in communication with the computing device may also be considered, such as toying with their mobile phone, or not interacting with the keyboard or mouse of their workstation for a threshold period of time.

Other examples of this data include physiological data that may be obtained from a fitness tracker worn by the user, such as information about sleep cycles—for example the timing, duration, and/or quality of the previous night's sleep. Similarly the user's recent and/or current heart rate, and a step count, impact (accelerometer) measurements or other indicators of exertion may be captured.

Any one or more of these data types may be provided in a further dataset. Moreover a plurality of further data set may be provided, for example corresponding to different sources such as motion tracking from the EVPS itself, user facial expression/speech from the mobile phone, and sleep data/heart rate from a fitness wearable. These may be treated as separate further data set, or amalgamated into one further dataset by the computing device.

ii. Data Relating to User Originating Circumstances:

Examples of this data include user-initiated activities, such as eating, commuting, working, exercising and the like. Activities such as working or exercising may be detected based on the user's current location with respect to a location such as a registered work site or gym. Commuting may be detected based on the user's movement as well as optionally their position (for example distinguishing between road and rail travel). This information may be determined from a combination of GPS data from a mobile phone and/or the EVPS itself, and optionally additional data, either available publicly in the case of road and rail locations or privately in the case of personal details registered by the user, for example as part of an on-line account associated with the management of their EVPS.

Similarly, social and other engagements may be determined with reference to a user's calendar on their phone.

It will be appreciated again that there may be correlations between usage of the EVPS and data relating to user-originating circumstances such as exercising, commuting or going to a party.

iii. Data Relating to External Circumstances.

Examples of this data include any broader environmental influence on the user's mood or activities that is not directly (or deliberately) caused/arranged by the user themselves. As an example of an environmental condition, a likely influence on the user is the local weather, currently and/or in the near future. Other factors may include for example sports results or news headlines in media consumed by the user (for example based on their observed newsfeed from a social media portal). Other factors that may influence a user's mood and behavior include their current bank balance and/or levels of spending, how recently they received a call from a friend or family member, their relationship status and the like.

Such external data may be collated by the mobile phone; for example weather data may be obtained from any suitable on-line source and/or any suitable weather service app on the phone. Similarly sports and news and other social media influences may be obtained from any suitable on-line source and/or any suitable social media app on the phone. Similarly bank data or a general assessment of liquidity may be obtained with the user's permission from a suitable app, or may be provided by the user through a user interface, for example on a weekly basis. Relationship statuses may be obtained via social media, and phone logs, SMS messages and the like may be analyzed for the state of interpersonal relationships with the user's permission.

Again it will be appreciated that there may be correlations between usage of the EVPS and such external circumstances. For example heavy rain may significantly reduce the user's propensity to use the EVPS, whilst sunshine significantly increases it. Meanwhile for example a negative news item may have a slight correlation with deeper or more frequent inhalations by the user due to a corresponding slight increase in stress.

There may also be other sources of data that span these classifications, or represent another broad category, or may be considered to fall outside them altogether.

For example a user originating circumstance may include visiting a doctor, or not visiting the gym at a scheduled/habitual time. These in turn may suggest the user is feeling poorly and hence are also indirect indicators of the physiological state of the user.

Meanwhile the time of day or the day of the week may optionally be not considered to be further datasets; clearly the time of day or the day of the week may be used when establishing correlations between the usage of the EVPS and features of a circumstance identifiable from one or more further datasets, but the current time and day of the week per se may be excluded from consideration as a further dataset in its own right. Nevertheless the time and day may be used as part of a separate mechanism for establishing habitual usage patterns of the user in parallel with the present disclosure, and these separate approaches may be combined for example by weighting the contribution of usage estimates from these and potentially other techniques to determine an overall response.

As noted previously, moreover a plurality of further datasets may be provided in any one or more of these broad categories.

It will be appreciated that some data (for example relating to the user's physiology, preferences or activities—such as their work location) may need to be explicitly provided by the user where not already available (for example the user's physiological data may be available from a partnered fitness app, whilst their work location can be inferred from their location during weekday working hours). Hence optionally the user may be provided with means to input this data to the system, for example by interacting with a website hosted by a service provider associated with the EVPS (for example the manufacturer or a trusted third party) that enables the user to open and maintain an account. The account associates the data with the user and their EVPS, and hence its usage data. The data may include directly input information and/or permissions to access other information (such as social media, a phone calendar, or data from a fitness device). Some such permissions may also be obtained when installing an app on the user's phone.

Also as noted previously, for each of these three broad categories any actual correlations will vary from user to user, and potentially from time period to time period.

Accordingly, in an embodiment of the disclosure the computing device is configured to identify a correspondence between usage in the first data set and one or more respective characteristic features of the further data set (or further data sets).

Examples of such correspondence have already been given previously herein. It will be appreciated that the features of some circumstances are localized either in time or space and typically correspond to events, such as going to the gym, whilst the features of some other circumstances are likely to be more like a continuous variable, with examples including the current weather or the user's heart rate. Still others may be a combination of the two, where sparse samples can be used to inform an ongoing indication of the user's state, such as occasional opportunities to analyze the user's facial expression or choice of language in communications via their phone, which may be sporadic.

The correspondences themselves may take any suitable form or forms, and may differ depending on the nature of the feature and associated data found derived from a further dataset. Hence for circumstances localized in time or space, the correlation with usage may be dependent upon proximity to that localized event (in other words the identified correspondence between usage in the first data set and one or more respective characteristic features of the further data set may be a correspondence in time). Meanwhile for continuous variables, correlation with usage may be dependent upon the variable's value (in other words the identified correspondence between usage in the first data set and one or more respective characteristic features of the further data set may be a correspondence between values and/or states).

It is also possible to consider cross correlations with multiple features; hence for example there may be a relatively low correlation between a high heart rate and increased usage for a particular user, except when commuting (which may be indicative of the user being stressed after work and have a particularly strong correlation with deep or frequent inhalation).

Similarly where multiple features of circumstances, and/or features of multiple circumstances are present, then optionally respective correlations with user behavior may be obtained. In some circumstances or combinations of circumstances these may reinforce each other towards a common outcome, whilst in other circumstances or combinations of circumstances they may dampen or cancel each other out so that the usage indicated by any one circumstance does not correspond to an aggregate of usage indicated by combining all such indicated usages. In this case, the system may either select the aggregate usage as a basis for modifying EVPS operation, or not implement any modification due to conflicting results, or only select a subset of the features according to a predetermined prioritization, optionally reducing the subset until a common indication of usage or deviation in indication of usage below a threshold is achieved.

These correlations can be identified by any suitable technique known in the art.

For some events that are relatively rare within an individual user's life, such as sickness, or changes in relationship status, optionally correlations identified based upon data from a corpus of a statistically significant number of users may be provided to bootstrap or seed the correlation for an individual user. In this case the corpus used to derive the correlation may be selected to be of a similar type to the individual user (for example based on age, gender and/or any other socio-economic indicators thought to be of relevance to the particular correlation).

Similarly, individual features may be combined into groups or types so as to provide more data with which to identify a correspondence with usage in the first dataset on a feature type basis. In some cases, these may simply be to avoid unnecessary granulation of the same basic feature—for example a weather app may identify drizzle, light rain, and heavy rain, but these may be combined into a single type (i.e. ‘rain’ or ‘bad weather’). Alternatively or in addition, features may be combined into a meta-feature type, so that bad weather, bad sports results, or reaching/leaving the workplace 20 minutes later than normal are all identified as a ‘bad day’ feature type. In this case, each could contribute to the value of a ‘bad day’ feature variable, optionally after suitable weighting.

More generally, features can be identified as being a positive type or a negative type and contribute to an overall good/bad measure for which correlation with the usage in the first dataset can be established.

It will be appreciated that the same feature can contribute to types at different levels, so that ‘heavy rain’ may have a clear correlation with usage in its own right, but also contribute to a more general ‘bad day’ feature type that may (or may not) correlate with a low mood in the user for some time after the rain has finished and hence changes in their usage behavior of the EVPS.

In any event, having calculated correlations between the first dataset of historic usage of the aerosol provision system (where historic simply means usage that has occurred in the past under any suitable timeframe, such as one of at least the last hour, day, week, or any period sustainable by data storage resources assigned by the designer of the computing device, and/or usage in association with prior events/circumstances each of a particular type, optionally independent of how long in the past), and one or more features of one or circumstances identifiable within data of one or more further datasets not relating to usage of the aerosol provision system to generate aerosol/vapor, then the computing device is ready to operate.

Accordingly, in an embodiment of the present disclosure, in response to a circumstance having a feature similar to a respective characteristic feature in a further data set, the computing device is operable to adjust one or more operational parameters of the aerosol provision system responsive to the corresponding usage of the aerosol provision system indicated in the first data set.

As noted above, various correspondences/correlations can be established between usage of the EVPS and features of circumstances in the or each further data set (for example for features of circumstances in any one or more of the different broad categories of circumstances listed previously herein).

Consequently, current data for at least a subset of the features used to establish correspondences/correlations may be used to anticipate/predict current usage by the user.

Hence if a correlation between deeper inhalation or more frequent inhalation and toying with the EVPS has been previously established, then motion data indicating that the EVPS is currently being toyed with may have a high correlation with increased demand for vapor.

Similarly if a correlation between less frequent inhalation and wet weather has been previously established, then weather data indicating heavy rain may have a high correlation with a decreased demand for vapor.

It will be appreciated that at any given moment not all features used to establish correspondences/correlations may have current values accessible to the computing device; for example the current facial expression of the user may not be available if the user's phone is in their pocket, and recent news headlines or weather reports may not be available if the user's phone is out of range for data. Meanwhile some features may be assumed to persist until subsequently updated, such as relationship status, and so the current circumstance does not need to be frequently checked. Furthermore in such cases it may be the change in circumstance that is the relevant feature, rather than the current value of the circumstance itself.

Hence not all features for which correspondences/correlations are known may be used when predicting a likely usage. Similarly as noted previously herein, even where current values for features are currently known, optionally not all features may be used to contribute to a prediction of likely usage, or features or feature values with little or no correlation may be discarded either permanently or for the current prediction.

The computing device thus uses one or more features of a current circumstance (or current circumstances, or a prioritized subset thereof selected according to a predetermined prioritization), and identifies the correlations between the or each feature and one or more aspects of usage of the EVPS.

The strength of each correlation with the one or more aspects of usage of the EVPS can be used to determine the extent to which the EVPS should be adjusted in anticipation of such an aspect of usage. Such adjustments may follow a linear or non-linear scale responsive to the strength of correlation, or may be classified according to a binary classification (e.g. states 0, 1) or multistate classification (e.g. states 0, 1, 2, 3) according to the strength correlation, such that an adjustment is on or off, or takes one of multiple forms/degrees. The specific nature of the adjustment may be selected depending upon what aspect of the EVPS is being adjusted.

Adjustments may take any suitable form. As noted previously, the amount of vapor/aerosol and hence active ingredient produced by the EVPS is typically a function of the temperature of the heater used to vaporize the payload. Hence as a first example where increased usage is indicated, the effective temperature of the heater may be increased by raising the temperature and/or altering a duty cycle of the heater. Similarly where decreased usage is indicated, the effective temperature of the heater may be decreased by reducing the temperature and/or altering a duty cycle of the heater. In each case, the delivery of active ingredient by the device will be more in tune with the inferred wishes of the user based on their historic patterns of usage in the face of the currently detected circumstances.

Similarly, the rate of delivery of the payload to the heater/atomizer may be adjustable to similar ends. This may be based on reducing a constriction in a wick, adjusting a valve, or the like.

Similarly, where more frequent usage is indicated, then optionally after inhalation the temperature of the heater may be reduced to a level below the vaporization temperature, but not completely turned off, so that the devices more responsive during periods of rapid inhalation. Such an option may be subject to a threshold frequency below which this approach is not used.

Again similarly, where short, sharp inhalations are indicated is likely (for example in stressful circumstances), then a profile of the vapor delivery may attempt to deliver vapor as quickly as possible after activation by raising the temperature of the heater above a normal operating temperature for a predetermined period. This predetermined period may be based on inhalation profiles and the like, and/or responsive to a detected peak airflow during the inhalation.

Conversely, where slow, deep inhalations are indicated is likely then a profile of the vapor delivery may be more even. If the system is aware of the nature of the payload, then for example in this case if the payload is strongly flavored then the device may provide a boost in vapor toward the end of the inhalation so as to increase subjective flavor.

In addition to direct adjustment to operational parameters of the vapor generation process, indirect adjustments can be made where the vapor generation process is already subject to other controls. Hence for example if the user has set a maximum usage allowance for the day, then in response to features of a circumstance indicative of heavy use previously then this maximum usage allowance may be increased.

Similarly, if the user is following a nicotine reduction program over the course of weeks or months, then in response to features of circumstance indicative of heavy use previously then the nicotine reduction program may pause for that day (e.g. not implement a per puff or per period nicotine delivery reduction, or a reduction in total allowance). Conversely, where features of circumstances indicate lighter than average use historically, then optionally the nicotine reduction program may skip forward a day or equivalently further reduction beyond the default daily increment.

Hence in such cases the operational parameters are adjusted at a predetermined variance to the corresponding usage (i.e. modifying a separately imposed usage regime).

The operational parameters need not be limited to direct or indirect generation of the vapor itself. For example if the EVPS has haptic feedback or other user interface elements, these may be adjusted as appropriate. For example if usage in response to a detected feature of a circumstance is indicative of stress, then haptic feedback may be reduced, and/or other interface elements may be modified, for example to reduce the volume or change the type of a notification sound (for example a sound used to indicate the need to change a reservoir). Similarly a threshold for notifying the user that a payload reservoir is running low may be increased so that notification occurs earlier; this may reduce the chances of the user no longer being able to use their EVPS during a stressful situation. A similar principle may apply to battery life. More generally, the content and/or frequency of device initiated user interface interactions may be altered (for example to reduce or increase the number of status notifications or reminders).

Whilst the above embodiments assume that data about usage for the first data set is about the individual user, and data about non-usage factors that can correlate with usage and that are included in the further data set is similarly about the user, optionally alternatively or in addition these can be provided as generic data, for example built into the EVPS or phone, for example to boot-strap the system with an expected generic response (or simply to provide that response, without any subsequent personalization to the user).

Hence for example the first data set and second data set could be provided by a combined data set provided at manufacture or downloadable as part of an app, that defines generic correlations between non-usage events and usage values; hence for example indicating a correlation between poor weather and a proportionate reduction in consumption. In this way, the EVPS or a phone co-operating with it could have a plurality of such conditions loaded or pre-loaded, and obtain the conditions and identify the correlations from this data set. In this case, the generation of personalized usage data, non-usage data and correlations between the two may then be implemented over time and use, or optionally not implemented, relying only on the loaded or pre-loaded generic data set.

The system could then compare the current circumstance with the existing scenarios to identify a suitable adjustment to one or more operational parameters. Again, these could also be stipulated by the combined data set.

Other modifications will be apparent to the skilled person, both on the EVPS itself and/or optionally on the mobile phone, particularly where this is used as the user interface or extension of it.

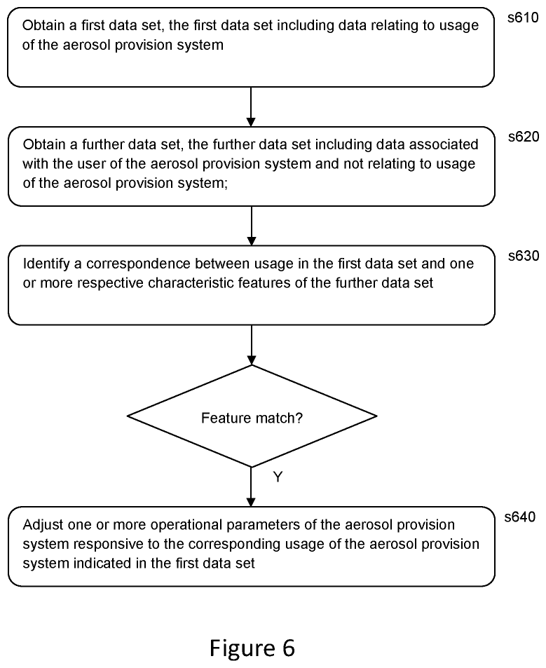

Turning now to FIG. 6, in an embodiment of the present disclosure an aerosol delivery method for use with an aerosol provision system configured to generate aerosol from an aerosol generating material for user inhalation is provided the method comprising:

At s610 obtaining a first data set, the first data set including data relating to usage of the aerosol provision system;

At s620, obtaining a further data set, the further data set including data associated with the user of the aerosol provision system and not relating to usage of the aerosol provision system;

At s630, identifying a correspondence between usage in the first data set and one or more respective characteristic features of the further data set; and
in response to a circumstance having a feature similar to a respective characteristic feature in the further data set, at s640 adjusting one or more operational parameters of the aerosol provision system responsive to the corresponding usage of the aerosol provision system indicated in the first data set.

It will be apparent to a person skilled in the art that variations in the above method corresponding to operation of the various embodiments of the method and/or apparatus as described and claimed herein are considered within the scope of the present disclosure, including but not limited to:
obtaining a further data set comprising obtaining a plurality of further data sets, and the step of identifying a correspondence comprising identifying a correspondence between usage in the first data set and one or more respective characteristic features of the further data sets;
identifying a correspondence comprising identify a correspondence between usage in the first data set and one or more respective types of feature of the or each further data set;
a further data set relating to one selected from the list consisting of an environmental condition, and a user interaction with a web site;
a data set that does not relate to a physiological aspect of the user;
the first data set relating to one or more selected from the list consisting of an inhalation profile of the user, and an amount of inhaled aerosol;
the identified correspondence between usage in the first data set and one or more respective characteristic features of the further data set being a correspondence in time and
operational parameters being adjusted in anticipation of the corresponding usage, or being adjusted at a predetermined variance to the corresponding usage.

It will be appreciated that the above methods may be carried out on conventional hardware (such as that described previously herein) suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realized in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Variants

Referring again to FIG. 1, as noted previously the EVPS may be a self-contained unit (commonly referred to as an e-cigarette, even if the device itself does not necessarily conform to the shape or dimensions of a conventional cigarette). Such an e-cigarette may comprise an airflow measuring means, a processing means and optionally one or more feedback means such as haptic, audio and/or light/display means.

Alternatively, referring to FIG. 5, again as noted previously an EVPS system may comprise two components, such as an e-cigarette 10 and a mobile phone or similar device (such as a tablet) 100 operable to communicate with the e-cigarette (for example to at least receive data from the e-cigarette), for example via Bluetooth®.

The mobile phone may then comprise the processing means and one or more feedback means such as haptic, audio and/or light/display means, alternatively o in addition to those of the e-cigarette.

Optionally an EVPS system may comprise an e-cigarette 10 operable to communicate with a mobile phone 100, in which the mobile phone stores one or more parameters or other data (such as data characteristic of one or more aspects of usage by the user) for the EVPS, and receives such parameters/data from the e-cigarette. The phone may then optionally perform processing on such parameters/data and either return processed data and/or instructions to the EVPS, display a result to the user (or perform another action) or forward processed and/or unprocessed parameters/data on to a remote server.

Optionally the mobile phone or the EVPS itself may be operable to wirelessly access data associated with an account of the user at such a remote server.

In another variant embodiment of the disclosure, a first EVPS of a user may communicate some or all of its user settings to another EVPS. The user settings may comprise settings related to an implementation of the above disclosed methods, such as data characteristic of user behavior, and/or data relating to modification of the EVPS operation.

Such data may be relayed between devices either directly (e.g. via a Bluetooth® or near-field communication) or via one or more intermediary devices, such as a mobile phone owned by the user of the two devices or a server on which the user has an account.

In this way, a user may easily share the data from one device to another, for example if the user has two EVPS devices, or if the user wishes to replace one EVPS device with another without losing accumulated personalization data.

Optionally in this embodiment, where the second EVPS differs in type from the first EVPS (for example by having a different default power level, or heating efficiency), then a conversion factor or look-up table for converting operational parameters from the first EVPS to the second EVPS may be employed. This may be provided in software or firmware of the second EVPS, and identify the first EVPS and hence the appropriate conversions when making direct communication (or where data is relayed without change via an intermediary such as a phone). Alternatively or in addition an app on the phone may provide the conversion, optionally downloading the relevant conversions in response to the identity of the first and second EVPS. Again, alternatively or in addition a remote server may provide the conversion, in response to the identity of the first and second EVPS as associated with a user's account.

The foregoing discussion discloses and describes merely exemplary embodiments of the present disclosure. As will be understood by those skilled in the art, the present disclosure may be embodied in other specific forms without departing from the essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A computing device for use with an aerosol provision system configured to generate aerosol from an aerosol generating material for user inhalation, the computing device configured to:
obtain a first data set, the first data set including data relating to usage of the aerosol provision system;
obtain one or more further data sets, each further data set including data associated with the user of the aerosol provision system and not relating to usage of the aerosol provision system;
identify a correspondence between usage in the first data set and one or more respective characteristic features of at least one of the one or more further data sets; and
in response to a circumstance having a feature similar to a respective characteristic feature in the at least one further data set, adjust one or more operational parameters of the aerosol provision system responsive to the corresponding usage of the aerosol provision system indicated in the first data set.

2. (canceled)

3. A computing device according to claim 1, in which the computing device is configured to:
identify a correspondence between usage in the first data set and one or more respective types of feature of each further data set; and
in response to a circumstance having a feature of the respective type identified in at least one further data set, adjust the operational parameters of the aerosol provision system responsive to the corresponding type of event in the first data set.

4. A computing device according to claim 1, in which at least one further data set of the one or more further data sets relates to one selected from the list consisting of:
i. an environmental condition; and
ii. a user interaction with a website.

5. A computing device according to claim 1, in which the or each further data set does not relate to a physiological aspect of the user.

6. A computing device according to claim 1, in which the first data set relates to one or more selected from the list consisting of:
i. an inhalation profile of the user; and
ii. an amount of inhaled aerosol.

7. A computing device according to claim 1 in which the identified correspondence between usage in the first data set and one or more respective characteristic features of at least one of the one or more further data sets is a correspondence in time.

8. A computing device according to claim 1 in which operational parameters are adjusted in anticipation of the corresponding usage.

9. A computing device according to claim 1 in which operational parameters are adjusted at a predetermined variance to the corresponding usage.

10. A system comprising the computing device according claim 1, in which the functions of the computing device are provided by one or more selected from the list consisting of:
i. a mobile phone operable to communicate with an electronic vapor provision system;
ii. an electronic vapor provision system; and
iii. a server operable to communicate with one or more of an electronic vapor provision system and a mobile phone itself operable to communicate with an electronic vapor provision system.

11. An aerosol delivery method for use with an aerosol provision system configured to generate aerosol from an aerosol generating material for user inhalation, the method comprising the steps of:
obtaining a first data set, the first data set including data relating to usage of the aerosol provision system;
obtaining one or more further data sets, each further data set including data associated with the user of the aerosol provision system and not relating to usage of the aerosol provision system;
identifying a correspondence between usage in the first data set and one or more respective characteristic features of at least one of the one or more the further data set; and
in response to a circumstance having a feature similar to a respective characteristic feature in the at least one further data set, adjusting one or more operational parameters of the aerosol provision system responsive to the corresponding usage of the aerosol provision system indicated in the first data set.

12. (canceled)

13. An aerosol delivery method according to claim 11, in which
the step of identifying a correspondence comprises identify a correspondence between usage in the first data set and one or more respective types of feature of the or each further data set.

14. An aerosol delivery method according to claim 11, in which
at least one further data set of the one or more further data sets relates to one selected from the list consisting of:
i. an environmental condition; and
ii. a user interaction with a website

15. An aerosol delivery method according to claim 11, in which
each further data set does not relate to a physiological aspect of the user.

16. An aerosol delivery method according to claim 11, in which the first data set relates to one or more selected from the list consisting of:
i. an inhalation profile of the user; and
ii. an amount of inhaled aerosol.

17. An aerosol delivery method according to claim 11, in which the identified correspondence between usage in the first data set and one or more respective characteristic features of at least one of the one or more further data sets is a correspondence in time.

18. An aerosol delivery method according to claim 11, in which operational parameters are adjusted in anticipation of the corresponding usage.

19. An aerosol delivery method according to claim 11, in which operational parameters are adjusted at a predetermined variance to the corresponding usage.

20. A non-transitory computer-readable medium storing instructions that, when executed by computer system, cause the computer system to perform the method of claim 11.
